(19) United States
(12) Patent Application Publication
(10) Pub. No.: US 2011/0073589 A1
(43) Pub. Date: Mar. 31, 2011

(54) THERMAL PROCESSING APPARATUS

(75) Inventor: Masahiro SHIMIZU, Yamanashi (JP)

(73) Assignee: TOKYO ELECTRON LIMITED, Tokyo (JP)

(21) Appl. No.: 12/889,507

(22) Filed: Sep. 24, 2010

(30) Foreign Application Priority Data
Sep. 29, 2009 (JP) 2009-223673

(51) Int. Cl. H05B 6/10

(52) U.S. Cl. 219/647

(57) ABSTRACT

Provided is a thermal processing apparatus where the heating is performed by using both the resistance heating and the electromagnetic wave heating thereby increasing the temperature rising speed. The thermal processing apparatus includes a metal-made processing container configured to be exhausted, a placing table including a resistance heating unit and configured to arrange the object to be processed on the upper surface thereof, a gas introduction unit configured to introduce a gas into the processing container; an electromagnetic wave introduction unit configured to introduce an electromagnetic wave into the processing container, and an apparatus control unit configured to control the thermal processing apparatus in its entirety. The heating is performed by the combination of the resistance heating unit placed on the placing table and the heating by the object to be processed itself performed by the electromagnetic wave introduced by the electromagnetic wave introduction unit.

This application is based on and claims priority from Japanese Patent Application No. 2009-223673, filed on Sep. 29, 2009, with the Japanese Patent Office, the disclosure of which is incorporated herein in its entirety by reference.

### TECHNICAL FIELD

The present disclosure relates to a thermal processing apparatus for performing a predetermined processing of a semiconductor wafer such as a silicon substrate etc. by irradiating electromagnetic wave such as microwave or high frequency wave to heat the semiconductor wafer.

### BACKGROUND

In general, in order to fabricate a desired semiconductor device, various thermal processes such as a film forming process, a pattern etching process, an oxidation/diffusion process, a quality modification process, and an annealing process are repeatedly performed on a semiconductor device. With a recent trend towards a high-density, a multilayered structure and a high-integration of a semiconductor device, a stricter specification for the thermal processing has been required every year; and especially, there have been demands for enhanced in-surface uniformity and higher film quality of wafers in the various thermal processes. For example, while processing a channel in a transistor (e.g., a semiconductor device) after ion-implanting of impurity atoms into the channel, an annealing process is usually carried out in order to activate the impurity atoms.

In this case, if the annealing process is performed for a long period of time, the atomic structure can be stabilized, but the impurity atoms may diffuse deeply into a direction of film thickness to penetrate throughout the channel. Therefore, the annealing process needs to be performed within a short time. That is, in order to stabilize the atomic structure while forming the channel with a thin film thickness without the penetration, it is necessary to rapidly elevate the temperature of the semiconductor wafer to a high temperature, and further, after the annealing process, to rapidly lower the temperature to a low temperature at which the diffusion does not occur.

In order to perform the thermal processing like this, a lamp annealing apparatus that uses a heating lamp to perform a lamp annealing and a thermal processing apparatus that uses an LED device or a laser device have been proposed. See, for example, U.S. Pat. No. 5,689,614 and Japanese Patent Laid-open Application No. 2004-134674. Further, a heating apparatus using a microwave with a wavelength longer than the wave band of a visible ray or an ultraviolet ray to heat a semiconductor wafer also has been proposed. See, for example, Japanese Patent Laid-open Application No. H5-21420, Japanese Patent Laid-open Application No. 2002-280380, and Japanese Patent Laid-open Application No. 2007-258286.

However, in the current situation, the conventional thermal processing apparatuses as described above, in case of the thermal processing such as the annealing process or the film forming process, cannot sufficiently respond to the thermal processing that has a short time constant for reaction rate, although it has sufficiently responded to the thermal processing that has a long time constant. In particular, in the current situation, the thermal processing apparatus using an electromagnetic wave, which is expected to be possible to elevate temperature at a high rate, requires time to elevate temperature from a room temperature to a middle-low temperature of about 600° C. so that the conventional thermal processing apparatuses cannot sufficiently realize a temperature elevation at a high rate expected on the whole.

### SUMMARY

According to an embodiment, there is provided a thermal processing apparatus for performing a thermal processing on an object to be processed, which comprises a metal-made processing container configured to be exhausted, a placing table including a resistance heating unit and configured to arrange the object to be processed on the upper surface thereof, a gas introduction unit configured to introduce a gas into the processing container, an electromagnetic wave introduction unit configured to introduce an electromagnetic wave into the processing container, and an apparatus control unit configured to control the thermal processing apparatus in its entirety.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a view illustrating a configuration of a thermal processing apparatus according to first embodiment of the present disclosure.

FIG. 2 is a graph illustrating the relationship between the driving of both a resistance heating unit and an electromagnetic wave introduction unit and the temperature of a semiconductor wafer.

FIG. 3 is a graph illustrating an exemplary temperature dependence on an absorption rate of electromagnetic wave in a silicon substrate.

FIG. 4 is a view illustrating a configuration of a thermal processing apparatus according to second embodiment of the present disclosure.

FIG. 5 is a lateral cross-sectional view illustrating schematically a heating means according to the second embodiment.

FIG. 6 is a view illustrating a configuration of a thermal processing apparatus according to third embodiment of the present disclosure.

FIG. 7 is a graph illustrating the relationship between a standardized radius of magnetic powder and absorption energy.

FIG. 8 is a graph illustrating the relationship between the driving of an electromagnetic wave introduction unit and a temperature of a semiconductor wafer.

FIG. 9 is a view illustrating a configuration of a thermal processing apparatus according to forth embodiment of the present disclosure.

FIG. 10 is a lateral cross-sectional view illustrating schematically a heating means according to the forth embodiment.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

The present disclosure provides a thermal processing apparatus which can obtain a high temperature rising speed by a combined using of a resistance heating and a heating by electromagnetic wave.

Further, the present disclosure provides a thermal processing apparatus which can obtain a high temperature rising speed using the heating only by electromagnetic wave.

According to the first embodiment of the present disclosure, there is provided a thermal processing apparatus for performing a thermal processing on an object to be processed. The thermal processing apparatus comprises a metal-made processing container configured to be exhausted, a placing table including a resistance heating unit and configured to arrange the object to be processed on the upper surface thereof, a gas introduction unit configured to introduce a gas into the processing container, an electromagnetic wave introduction unit configured to introduce an electromagnetic wave into the processing container, and an apparatus control unit configured to control the thermal processing apparatus in its entirety.

According to the above first embodiment of the present disclosure, a high temperature rising speed can be obtained because the resistance heating by the resistance heating unit provided in the placing table and the heating of the object to be processed itself by electromagnetic wave introduced by the electromagnetic wave introduction unit are used in combination.

According to the second embodiment of the present disclosure, there is provided a thermal processing apparatus for performing a thermal processing on an object to be processed. The thermal processing apparatus comprises a metal-made processing container configured to be exhausted and formed in a cylindrical body shape so as to accommodate a plurality of objects to be processed, a holding means configured to hold the plurality of objects to be processed and to be inserted or withdrawn into/from the processing container, a heating means provided to surround the holding means in the processing container and including a resistance heating unit, a gas introduction unit configured to introduce a gas into the processing container, an electromagnetic wave introduction unit configured to introduce an electromagnetic wave into the processing container, and an apparatus control unit configured to control the thermal processing apparatus in its entirety.

According to the above second embodiment of the present disclosure, a high temperature rising speed can be obtained because the resistance heating by the resistance heating unit provided in the heating means and the heating of the object to be processed itself by electromagnetic wave introduced by the electromagnetic wave introduction unit are used in combination.

Further, in the first and the second exemplary embodiments, the thermal processing apparatus may further comprise a temperature sensor unit configured to measure a temperature of the object to be processed.

Further, in the first and the second exemplary embodiments, the apparatus control unit may be configured to turn on the electromagnetic wave introduction unit in response to a detection result from the temperature sensor unit that detects a predetermined temperature after turning on the resistance heating unit.

Further, in the first and the second exemplary embodiments, the predetermined temperature may be 300° C. or more.

According to the third embodiment of the present disclosure, there is provided a thermal processing apparatus for performing a thermal processing on an object to be processed. The thermal processing apparatus comprises a metal-made processing container configured to be exhausted, a placing table configured to accommodate the object to be processed and having a built-in magnetic powder heating unit made by collecting magnetic powder, a gas introduction unit configured to introduce a gas into the processing container, an electromagnetic wave introduction unit configured to introduce an electromagnetic wave into the processing container, and an apparatus control unit configured to control the thermal processing apparatus in its entirety.

According to the above third embodiment of the present disclosure, a high temperature rising speed can be obtained because the heating by electromagnetic wave of the magnetic powder heating unit provided in the placing table and the heating by electromagnetic wave of the object to be processed itself are used in combination.

According to forth embodiment of the present disclosure, there is provided a thermal processing apparatus for performing a thermal processing on an object to be processed. The thermal processing apparatus comprises a metal-made processing container configured to be exhausted and formed in a cylindrical body shape so as to accommodate a plurality of objects to be processed, a holding means configured to hold the plurality of objects to be processed and to be inserted or withdrawn into/from the processing container, a heating means provided to surround the holding means in the processing container and having a built-in magnetic powder heating unit made by collecting magnetic power, a gas introduction unit configured to introduce a gas into the processing container, an electromagnetic wave introduction unit configured to introduce an electromagnetic wave into the processing container, and an apparatus control unit configured to control the thermal processing apparatus in its entirety.

According to the above forth embodiment of the present disclosure, a high temperature rising speed can be obtained because the heating by electromagnetic wave of the magnetic powder heating unit provided in the heating means and the heating by electromagnetic wave of the object to be processed itself are used in combination.

Further, in the third and the forth exemplary embodiments, the magnetic power material may be composed of one or more materials selected from a group consisting Fe, Ni, Co, MgO, Fe₃Si, iron oxide, chrome oxide and ferrite.

Further, in the third and the forth exemplary embodiments, the standardized radius of the magnetic power material may be within a range of 1.0 to 10.

Further, in the first through the forth exemplary embodiments, the frequency of the electromagnetic wave may be within a range of 0.5 GHz to 5 THz.

Hereinafter, exemplary embodiments of the present disclosure will be described in detail with reference to the accompanying drawings which form a part thereof.

### First Embodiment

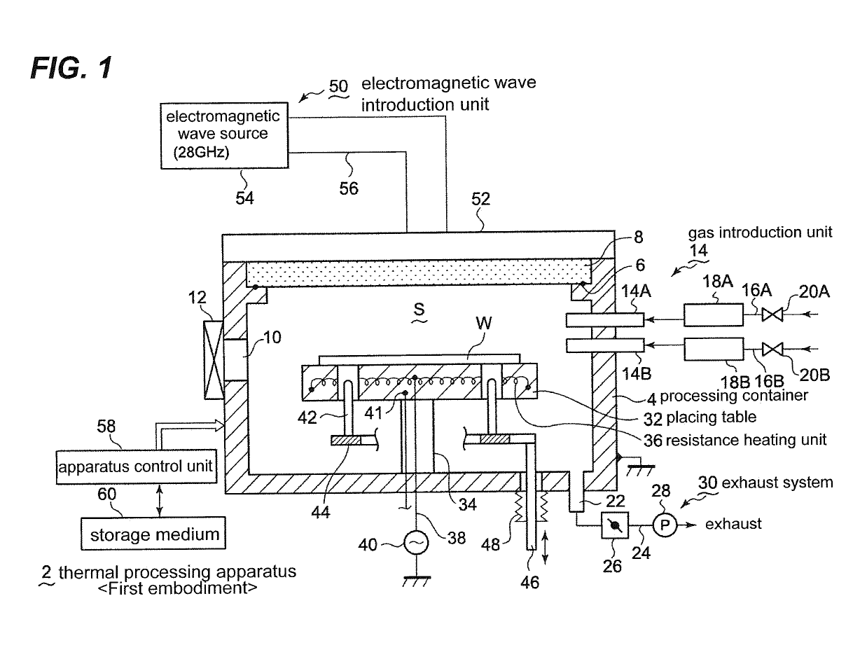

First, a thermal processing apparatus according to the first embodiment of the present disclosure will be explained. FIG. 1 is a view illustrating the configuration of the thermal processing apparatus of the first embodiment of the present disclosure. Herein, a film forming process will be described as an example of a thermal processing.

As shown in FIG. 1, a thermal processing apparatus 2 includes a cylindrical-shaped processing container 4 made of metal such as stainless steel, aluminum, aluminum alloy or the like. Processing container 4 is mirror-finished on the inner surface in order to easily reflect the introduced electromagnetic wave. Processing container 4 is set to have a size capable of accommodating a semiconductor wafer W comprised of a thin disc type silicon substrate having a diameter of, for example, 300 mm which is an object to be processed. Processing container 4 itself is grounded. Processing container 4 is opened on a ceiling part. A transmission plate 8 is installed in airtight for transmitting electromagnetic wave, which will be described later, on the ceiling part by means of a sealing member 6 such as an O-ring or the like. As materials for transmission plate 8, ceramic e.g., quartz, aluminum nitride or the like is used.

Further, an opening 10 is formed on a sidewall of processing container 4, and a gate valve 12, which is opened and closed when the substrate (e.g., the semiconductor wafer W) is loaded or unloaded, is provided on opening 10. Further, a gas introduction unit 14 is provided in processing container 4 for introducing a gas necessary for a processing. Herein, gas introduction unit 14 includes a plurality of gas nozzles (e.g., two gas nozzles 14A, 14B in this illustrated example) provided on the sidewall of processing container 4, and each of gas lines 16A, 16B is connected to each of gas nozzles 14A, 14B, respectively. Flow rate controllers 18A, 18B such as mass-flow controller for controlling a gas flow rate and gas switch valves 20A, 20B are interposed in midstream of respective gas lines 16A, 16B, thereby supplying a gas necessary for processing (e.g., a film forming gas or an inert gas such as N₂ or the like) while controlling the flow rate of the gas. Also, the number of gas nozzles is not limited to two, and may be increased or decreased depending on the type of gas used.

Furthermore, as for gas introduction unit 14, a shower head made of a material which is transparent for electromagnetic wave, such as quartz, may be provided right under the ceiling part of processing container 4, instead of the gas nozzles. Also, an exhaust opening 22 is formed on the vicinity of the bottom part of processing container 4, and an exhaust system 30 configured by interposing a pressure control valve 26, an exhaust pump 28 such as a vacuum pump and the like at an exhaust passage 24, is connected to exhaust opening 22. Thus, the inside of processing container 4 can be exhausted to a depressurized atmosphere including a vacuum state.

Further, a placing table 32 which is for arranging the semiconductor wafer W on the top surface thereof is provided in processing container 4. Placing table 32 is supported by a cylindrical supporting column 34 which stands from the bottom part of processing container 4. Formed in placing table 32 is a built in resistance heating unit 36. As material for placing table 32, ceramic material such as silicon carbide, aluminum nitride or the like can be used. Also, a carbon wire heater, a tungsten heater or the like can be used as resistance heating unit 36. Resistance heating unit 36 may be formed to be a single heating zone as a whole or may be divided into several zones in a concentric circle shape so as to control the temperature for each of the zones.

Resistance heating unit 36 is connected to a feed line 38 inserted through the inside of supporting column 34 and supplies the heater power via feed line 38 from a power source 40. Further, placing table 32 includes a temperature sensor 41 made of, for example, a thermocouple so as to detect the temperature of the semiconductor wafer W.

Moreover, lifter pins 42 which are lifted when loading and unloading the semiconductor wafer W are provided under placing table 32. Three lifter pins 42 are provided at intervals of 120° in a concentric circle shape (in the illustrated example, only two are shown) and are supported respectively on lifting bases 44 formed of a circular arcs shape. Lifting bases 44 are connected to a lifting rod 46 which penetrate the bottom part of processing container 4, and are configured to lift lifter pins 42 by an actuator (not shown) as described above. Also, in the penetrating part of lifting rot 46, metal bellows 48 are provided configured to be expanding or contracting to maintain the airtight of inside processing container 4.

Further, an electromagnetic wave introduction unit 50 is provided over transmission plate 8 of processing container 4 for irradiating electromagnetic wave toward the semiconductor wafer W. Herein, electromagnetic wave may have a frequency range of 0.5 GHz to 5 THz. Hereinafter, an example using electromagnetic wave having a microwave band of 28 GHz will be described as an embodiment.

Specifically, electromagnetic wave introduction unit 50 includes an incidence antenna member 52 provided on the top surface of transmission plate 8 and an electromagnetic wave source 54 for generating electromagnetic wave having a frequency range of, for example, 0.5 GHz to 5 THz. And, incidence antenna member 52 and electromagnetic wave source 54 are connected through a waveguide 56. For example, gyrotron, magnetron, klystron, traveling-wave tube or the like can be used as electromagnetic wave source 54. Specifically, the electromagnetic wave having a frequency of 28 GHz as described above can be used, and additionally, electromagnetic wave having a frequency of 77 GHz, 82.7 GHz, 107 GHz, 110 GHz, 140 GHz, 168 GHz, 171 GHz, 203 GHz, 300 GHz, 874 GHz or the like can be used.

Further, the electromagnetic wave output from electromagnetic wave source 54 is induced to incidence antenna member 52 provided on transmission plate 8 through waveguide 56 formed with, for example, a rectangular waveguide or a corrugated waveguide. And, incidence antenna member 52 is provided with a plurality of reflection lenses with a mirror surface or reflection mirrors, thereby reflecting and introducing the induced electromagnetic wave toward a processing space S in processing container 4.

In this case, the reflected electromagnetic wave is transmitted through transmission plate 8, introduced into processing space S, and irradiated directly on the surface of the semiconductor wafer W, thereby heating the semiconductor wafer W.

The entire operations of thermal processing apparatus 2 is controlled by an apparatus control unit 58 formed with, for example, a microcomputer. And a computer program for executing the operation may be stored in a storage medium 60 such as a flexible disc, a compact disc (CD), a flash memory, a hard disc or the like. Specifically, in response to the instructions from apparatus control unit 58, the supply of the gas or a flow rate control of the gas, the supply of a power of electromagnetic wave, a processing temperature or pressure, and the like are controlled.

<Operation Description>

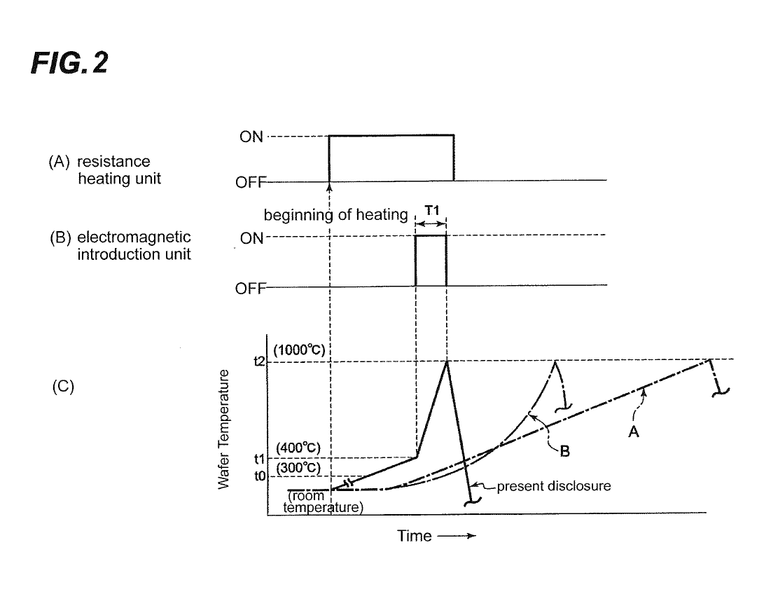

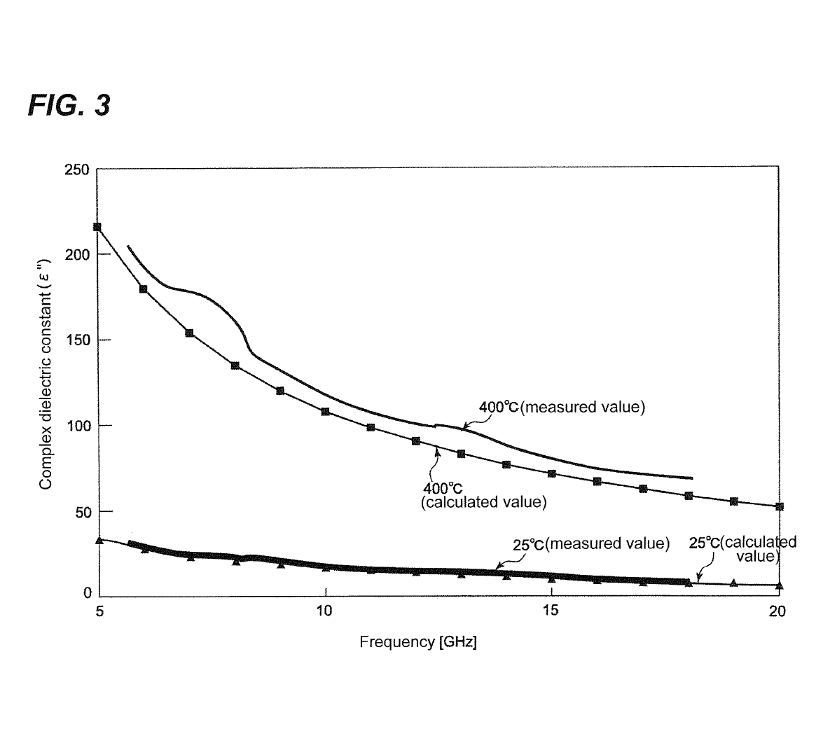

Next, a thermal processing using the thermal processing apparatus as configured above will be now described with reference to FIGS. 2 and 3. FIG. 2 is a graph illustrating the relationship between the driving of both the resistance heating unit and the electromagnetic wave introduction unit and the temperature of the semiconductor wafer. FIG. 2(A) is a view illustrating the operating condition of the resistance heating unit, FIG. 2(B) is a view illustrating the operating condition of the electromagnetic wave introduction unit, and FIG. 2(C) is a graph illustrating schematically the temperature variation of the semiconductor wafer. FIG. 3 is a graph illustrating an exemplary temperature dependence of the absorption rate of electromagnetic wave in a silicon substrate.

First, the semiconductor wafer W is accommodated into processing container 4 by a transfer arm (not shown) via an opened gate valve 12 and then the semiconductor wafer W is placed on placing table 32 by moving lifter pins 42 in an up/down direction. Gate valve 12 is then closed to seal the inside of processing container 4. In this case, a semiconductor wafer of a single element (e.g., a silicon substrate) is used as the semiconductor wafer W.

Next, processing container 4 is exhausted by exhaust system 30, and gases necessary for film forming process are supplied from each of gas nozzles 14A, 14B of gas introduction unit 14 to processing container 4 while controlling the flow rate. In this case, the inside of processing container 4 may be maintained at a processing pressure at which plasma is not generated. This processing pressure may be, for example, in the range of 0.13 Pa and 1.3 Pa. Also, according to the processing type, the processing may be performed at an atmospheric pressure or the vicinity thereof.

At the same time, apparatus control unit 58 begins to heat the semiconductor wafer W [see FIG. 2(A)] by starting to supply the electric current from power source 40 to resistance heating unit 36 provided in placing table 32 and elevates the temperature of the semiconductor wafer W to a predetermined temperature. Then, the temperature of the semiconductor wafer W has been detected by temperature sensor 41, and when the semiconductor wafer W reaches the predetermined temperature t1 [see FIG. 2(C)], apparatus control unit 58 drives electromagnetic wave source 54 of electromagnetic wave introduction unit 50 to be switched on additionally for a short period T1 [see FIG. 2(B)].

With these operations, the microwave generated in electromagnetic wave source 54 is supplied into incidence antenna 52 via waveguide 56 to be irradiated and then penetrate transmission plate 8, thereby introducing the microwave into the processing space S. The microwave introduced into the processing space S is irradiated on the surface of the semiconductor wafer W.

With these operations, the temperature of the semiconductor wafer W, which has been heated by resistance heating unit 36 to some degree, is rapidly elevated by irradiating with the electromagnetic wave. The irradiation time of electromagnetic wave T1 is, for example, about 100 msec to 10 sec. The temperature rising rate at this rapid temperature elevation is, for example, about 200° C./sec. Then, when the temperature reaches a processing temperature t2 of, for example, 1000° C., in a short period through this rapid temperature elevation, the heating of the semiconductor wafer W is stopped and then the semiconductor wafer W is cooled down naturally. And, at the time of the above rapid temperature elevation, a reaction with a short time constant, herein a film forming reaction, is carried out.

As described above, at the beginning of heating, the semiconductor wafer W is heated by the heat from resistance heating unit 36 as shown in FIG. 2(A) and, when the semiconductor wafer W reaches the predetermined temperature t1, e.g., 400° C., electromagnetic wave source 54 is switched on to introduce electromagnetic wave into the processing space S as shown in FIG. 2(B). The reason for this is that in the range that the temperature of the semiconductor wafer W is from room temperature to, for example, 600° C., the heating by electromagnetic wave cannot be expected because the number of free electrons in the silicon substrate is very small in that temperature range.

Therefore, in the above temperature range, the semiconductor wafer W is heated by the heat from resistance heating unit 36 thereby generating large amounts of free electrons in the silicon substrate, and then at the time when the free electron density increases due to the generation of the large amounts of free electrons which contribute to the heating by electromagnetic wave, electromagnetic wave is irradiated as described above thereby elevating the temperature of the semiconductor wafer W rapidly up to the processing pressure. The free electron density increases up to several times to 20 times by the heating, though it depends on a material or temperature of the semiconductor wafer in general.

In FIG. 2(C), curve A shows an example of temperature elevation characteristics of the semiconductor wafer W heated only by resistance heating unit 36 (electromagnetic wave is not used.) and curve B shows an example of temperature elevation characteristics of the semiconductor wafer W heated only by electromagnetic wave (resistance heating unit 36 is not used.). Thus, it is understood that both of them have a lower average temperature rising rate and a lower throughput in operation. In particular, it is understood that in the heating only by resistance heating unit 36 as shown in curve A, the time for the semiconductor wafer W to be exposed in condition of high temperature close to the processing temperature becomes so long that it cannot respond to particularly the chemical reaction rate having a short time constant.

Herein temperature dependence on absorption of electromagnetic wave of a semiconductor wafer temperature is verified, so the experimental results will be described with reference to FIG. 3. In FIG. 3, the cross axis represents frequency and the vertical axis represents complex dielectric constant (∈″), which corresponds to energy absorption rate. The complex dielectric constant (∈″) is measured by a free-space method. Herein, FIG. 3 represents a state where each of the semiconductor wafer of 25° C. (room temperature) and the semiconductor wafer of 400° C. is heated by electromagnetic wave with varying frequency, and both of a measured value and a calculated value are obtained together. As apparent from the graph, the measured value is well coincide with the calculated value. And, it is understood that when the temperature of a semiconductor wafer is low, the complex dielectric constant is low due to the low free electron density so that the semiconductor wafer may not be heated enough. In contrast, if the temperature of the semiconductor wafer becomes 400° C., while there exist frequency dependence, an absorption rate becomes quite high compared with the case of 25° C. so that the free electron density becomes high thereby obtaining a high temperature rising speed.

Herein, although the predetermined temperature t1 [see FIG. 2(C)], at which the irradiation of electromagnetic wave begins, depends on a material of an object to be heated, it may be 300° C. for a silicon substrate. Because when the predetermined temperature t1, at which the irradiation of electromagnetic wave begins, is below 300° C., free electron density in the semiconductor wafer may not be enough.

Next, a principle that the semiconductor wafer W made of a silicon substrate is heated by electromagnetic wave will be briefly described. At first, power P [w/m³] of electromagnetic wave heating is calculated using the following equation:

P=σ·|E|²/2+π·f·μo·μr·|H|²+πf·∈o·∈r·|E|²

Herein, each symbol is as follows.

σ: conductivity of silicon substrate [S/m]

E: electric field intensity [V/m]

f: frequency [1/sec]

μo: permeability of vacuum [H/m]

μr: relative permeability of silicon substrate

H: magnetic field intensity [A/m]

∈o: dielectric constant of vacuum [F/m]

∈r: relative dielectric constant of silicon substrate

Herein, the first term on the right side of the equation “σ·|E|²/2” denotes a joule heating, the second term “π·f·μo·μr·|H|²” denotes a magnetic heating, and the third tern “π·f·∈o·∈r·|E|²” denotes a dielectric heating.

Further, according to the characteristics of heated materials, three heating types of the joule heating, the magnetic heating and the dielectric heating contribute unilaterally or jointly to the heating of material for film forming. The joule heating is provided by induced eddy currents. The magnetic heating is provided in such a way that the electron spins that generates the magnetic property with respect to the magnetic components of electromagnetic waves respond, and then due to a spontaneous magnetization, the variance in internal energy is converted to phonon. And, the dielectric heating is provided in such a way that a molecule having a polarity for electric fields of electromagnetic waves responds and vibrates in proportion to the value of dielectric dissipation which is the product of relative dielectric constant (Er) and dissipation factor (tan δ). However herein since the heated material is the silicon substrate, the joule heating among the above three types of heating, elevates temperature of the semiconductor wafer mainly as described above.

Thus, according to the first embodiment of the present disclose, the resistance heating by resistance heating unit 36 provided in placing table 32 and the heating of the object to be processed itself by electromagnetic wave introduced by electromagnetic wave introduction unit 50 are used in combination, so that it can obtain a high temperature rising speed.

### Second Embodiment

Next, a thermal processing apparatus according to the second embodiment of the present disclosure will be described. Herein, a film forming process will be described as an example of a thermal processing. Although a single wafer type thermal processing apparatus for processing one semiconductor wafer at a time has been described as an example in the above first embodiment, a batch type thermal processing apparatus capable of processing a plurality of semiconductor wafers at a time will be described herein.

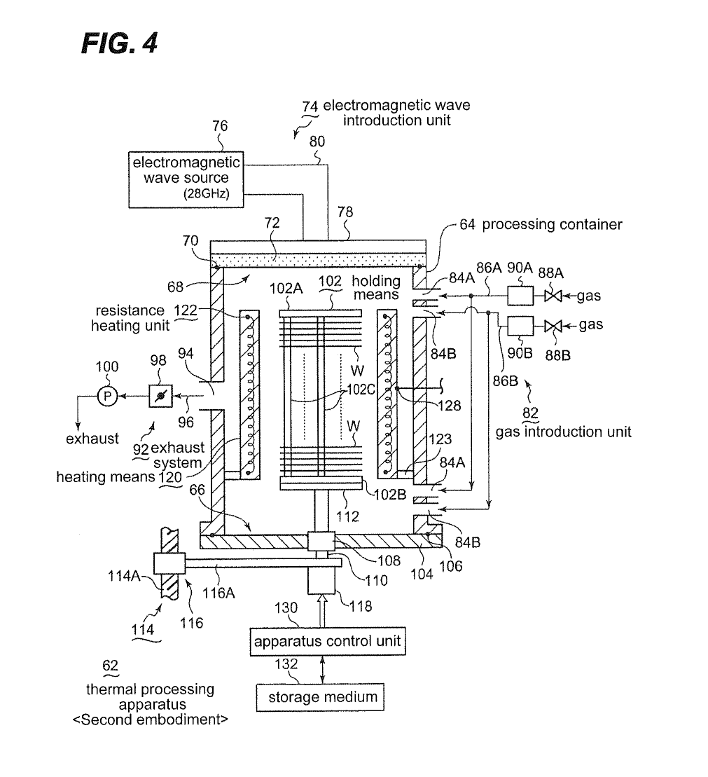

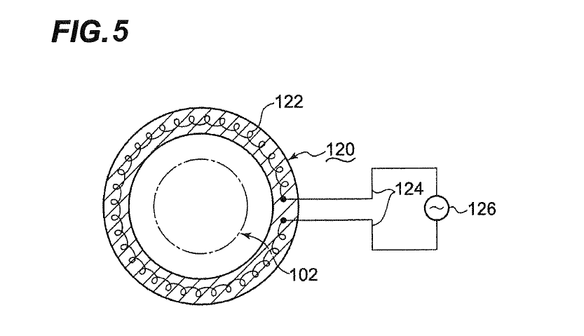

FIG. 4 a view illustrating the configuration of the thermal processing apparatus according to the second embodiment of the present disclosure and FIG. 5 is a lateral cross-sectional view illustrating schematically a heating means of the second embodiment. As shown in FIG. 4, thermal processing apparatus 62 includes a metal-made processing container 64 set to have a predetermined length. Processing container 64 is formed with a cylindrical body shape or a prism shape with a rectangular cross-section, and herein the longitudinal direction thereof is placed along with the direction of gravity, thereby constituting so-called a vertically long processing container 64. As for the metal which constitute processing container 64, for example, stainless steel, aluminum, aluminum alloy or the like is used, and the inner surface thereof is mirror-finished, so that the introduced electromagnetic wave is multiply reflected thereby effectively heating the semiconductor wafer W made of, for example, a silicon substrate which is an object to be processed.

A lower end of a compartment wall for comparting processing container 64 is opened and forms a loading/unloading port 66, and an upper end of the compartment wall is opened to form an electromagnetic wave introducing port 68.

Further, electromagnetic wave introducing port 68 is provided with a transmission plate 72 through a seal member 70 such as O-ring. Transmission plate 72 is made of a material which transmits electromagnetic wave and, herein, is formed of a ceramic material such as quartz, aluminum nitride or the like.

Further, provided on the outside of transmission plate 72 is an electromagnetic wave introduction unit 74 which is for introducing electromagnetic wave into processing container 64. Specifically, electromagnetic wave introduction unit 74 includes an electromagnetic wave source 76 for generating electromagnetic wave, an incidence antenna member 78 provided on the upper side, which is outside of transmission plate 72, a waveguide 80 for connecting electromagnetic wave source 76 and incidence antenna member 78 thereby guiding electromagnetic wave toward incidence antenna member 78. Electromagnetic wave having a frequency range of, for example, 0.5 GHz to 5 THz can be used as for the electromagnetic wave generated in electromagnetic wave source 76 as in the first embodiment.

Magnetron, klystron, traveling-wave tube, gyrotron or the like can be used as electromagnetic wave source 76. Herein, gyrotron is established as electromagnetic wave source 76 and electromagnetic waves have a frequency of 28 GHz. Also, the gyrotron can also generate electromagnetic wave having a frequency of 82.9 GHz, 110 GHz, 168 GHz, 874 GHz or the like.

Further, waveguide 80 is formed with, for example, a rectangular waveguide or a corrugated waveguide. And incidence antenna member 78 is provided with a plurality of reflection lenses with mirror surfaces or reflection mirrors, which are not shown, thereby configured to introduce electromagnetic wave toward processing container 64. In addition, processing container 64 is provided with a gas introduction unit 82 for introducing a gas necessary for the film forming. Specifically, herein gas introducing openings 84A, 84B are formed on both sides of the upper sidewall and the lower sidewall in pairs, respectively, and each of gas lines 86A, 86B is branched and connected respectively to each of gas introduction openings 84A, 84B.

Further, open/close valves 88A, 88B and flow rate controllers 90A, 90B such as mass-flow controller are interposed respectively in midstream of respective gas lines 86A, 86B, thereby supplying the gas necessary for the film forming process while controlling the flow rate. Herein, the gas necessary for a film forming process may be used in a single kind of gas or several kinds of gas, and inert gas or noble gas such as N₂ gas, Ar gas or the like can be introduce as fuzzy gas. Further, the number of gas introducing openings 84A, 84B is not limited to four. Further, gas nozzles made of quartz etc. may be used instead of theses gas introducing openings.

Further, processing container 64 is provided with an exhaust system 92 for exhausting the inner atmosphere thereof. Specifically, an exhaust opening 94 is provided on the center part of the sidewall of processing container 64 with a height which faces gas introducing openings 84A, 84B, and an exhaust passage 96, which comprises a part of exhaust system 92, is connected to exhaust opening 94. Also, in the midstream of exhaust passage 96, a pressure control valve 98, formed with, for example, a butterfly valve, and an exhaust pump 100 are sequentially interposed toward the downstream side, thereby configured to exhaust the atmosphere of the inside of processing container 64. In this case, the process inside the processing container may be carried out in a vacuum atmosphere or an atmospheric pressure (including the vicinity thereof), and when the processing is carried out in a vacuum atmosphere, it is possible to use a combination of a turbo molecular pump and a dry pump as exhaust pump 100 which can obtain a high vacuum degree.

Further, a holding means 102, which spaces a plurality of semiconductor wafers W as objects to be processed with predetermined intervals and holds them, is provided in processing container 64 such that it can be inserted thereto and withdrawn therefrom. The entire holding means 102 is formed with a material such as, for example, quartz which transmits the electromagnetic wave. Specifically, for example, four quartz-made supporting columns 102C are provided between an upper plate 102A and a bottom plate 102B, which are made of quartz and provided in an up and down direction of holding means 102. Coupling grooves (not shown) are formed in each of supporting columns 102C with a predetermined pitch, and the peripheries of the semiconductor wafers W are arranged on the coupling grooves so that the semiconductor wafers W can be supported with the predetermined pitch.

In this case, each of four supporting columns 102C is arranged at predetermined intervals along the semi-arc area of the semiconductor wafer W in order to insert or separate the semiconductor wafer W from a horizontal direction from holding means 102 using a transfer arm (not shown). Herein, the semiconductor wafer W is formed with a circular plate shaped thin film, a diameter thereof is set to be, for example, 300 mm, and 10 through 150 sheets of the semiconductor wafers W can be supported with a predetermined pitch. Also, the diameter of the semiconductor wafer W is not limited to 300 mm, and semiconductor wafers having diameters of 200 mm, 450 mm or the like can also be used.

Further, a covering opening/closing unit 104 made of the same metal as the constituent material of processing container 64 is attached to loading/unloading port 55 of the lower part of processing container 64 through a seal member 106 such as O-ring so as to be removable, and the inner surface of covering opening/closing unit 104 is mirror-finished in order to reflect the introduced electromagnetic wave.

Covering opening/closing unit 104 is provided with a rotational shaft 110 on the center part in such a way that rotational shaft 110 airtightly penetrates covering opening/closing unit 104 by interposing a magnetic fluid seal 108. Rotational shaft 110 is provided with a placing table 112 on the upper part thereof, and holding means 102 is arranged on the upper surface of placing table 112 thereby supporting placing table 112. Provided on the lower side of processing container 64 is a loading/unloading means 114 for loading or unloading holding means 102 from processing container 64.

Herein, there is provided with a lifting elevator 116 using a ball screw 14A functioning as loading/unloading means 114, and a lifting arm 116 A of lifting elevator 116 supports the lower part of rotational shaft 110 at the front end so that rotational shaft 110 can rotate. Herein, lifting elevator 116 is provided with a rotary motor 118 attached thereto thereby rotating holding means 102 provided on placing table 112 at a predetermined speed by rotating rotational shaft 110 during the processing. Accordingly, lifting elevator 116 is driven to elevate lifting arm 116A, thereby integrally moving covering opening/closing unit 104 and holding means 102 as one body in an up and down direction, so that it is possible to load and unload the semiconductor wafer W for processing container 64. Moreover, the semiconductor wafers W may be processed without rotating holding means 102, and in this case, rotary motor 118 or magnetic fluid seal 108 may not be necessary.

Further, a heating means 120 which is specific for the present disclose is provided in processing container 64 so as to enclose the entire surroundings of holding means 102. As shown in FIG. 5, heating means 120 is formed with a molded cylindrical body and provided with an embedded resistance heating unit 122 along the entire height. The lower part of heating means 120 is supported by a plurality of support arms 123 provided on the sidewall of processing container 64. Resistance heating unit 122 is connected to a power source 126 via a feed line 124 (see FIG. 5). A material of- heating means 120 is the same material as placing table 32 in the first embodiment, and ceramic material such as silicon carbide, aluminum nitride or the like can be used.

Further, as resistance heating unit 122, carbon wire heater, tungsten heater or the like can be used. Resistance heating unit 122 may be formed to be a single heating zone or may be divided into several zones so as to control the temperature for each of the zones. Heating means 120 is provided with a temperature sensor 128 formed with, for example, a thermocouple (TC), thereby configured to detect the temperature of the semiconductor wafer W.

The operation of entire thermal processing apparatus 62 is controlled by an apparatus control unit 130 equipped with, for example, a computer, and a computer program to execute the operation is stored in a storage medium 132 such as a flexible disc, CD (Compact Disc), hard disc, flash memory, DVD or the like. Specifically, in response to instructions from apparatus control unit 130, the start or stop of gas supply, a flow rate, power of electromagnetic wave, a processing temperature, a processing pressure, and the like are controlled.

<Description of Operation>

Next, the operation of thermal processing apparatus 62 configured as above will be described. At first, unprocessed semiconductor wafers W are supported in multi-stages of holding means 102 formed with the wafer boat while lifting elevator 116 which is loading/unloading means 114 is lowered. Next, lifting elevator 116 is driven to elevate lifting arm 116A steadily, thereby loading the semiconductor wafers W by introducing holding means 102 for holding the semiconductor wafers W into processing container 64 from loading/unloading port 66 of the lower end of processing container 64. When holding means 102 is completely loaded into processing container 64, loading/unloading port 66 of the lower end of processing container 64 is closed in airtight by covering opening/closing unit 104.

When the loading of the semiconductor wafer W into processing container 64 is completed, and a predetermined processing for the semiconductor wafer W is carried out. Herein, a film forming process is carried out in a vacuum atmosphere as the predetermined thermal processing. At first, the inside of processing container 64 is exhausted through a vacuum pumping by exhaust system 94 provided in processing container 64, and then a gas necessary for the film forming is introduced inside processing container 64 from gas introduction unit 82 while the flow rate is controlled, thereby maintaining a predetermined processing pressure in processing container 64 by a pressure control valve 98. And, holding means 102 that holds the semiconductor wafer W is rotated. Holding means 102 may be fixed without being rotated during the processing.

Hereinafter, a film forming process is carried out in the same step as described above in the first embodiment with reference to FIG. 2. In other words, an electric current begins to be applied into resistance heating unit 122 of heating means 120 thereby starting to heat the semiconductor wafer W up to the predetermined temperature t1 [see FIG. 2(C)]. The temperature of the semiconductor wafer W during the elevation has been detected by temperature sensor 128, and when the semiconductor wafer W reaches the predetermined temperature t1, apparatus control unit 130 additionally drives electromagnetic wave source 76 of electromagnetic wave introduction unit 74 to be switched on for the short period of T1 thereby introducing microwave into processing container 64. As a result, the temperature of the semiconductor wafer W is elevated rapidly at a temperature rising rate of, for example, 200° C./sec as is the case of the first embodiment so that it reaches a desired processing temperature. The temperature of the semiconductor wafer W at this time is changed in a similar pattern as explained in FIG. 2, and a film forming is carried out during the rapid temperature elevation.

Thus, the second embodiment has an operational effect similar to that of the above first embodiment. In addition, although electromagnetic wave introduction unit 74 is provided on the ceiling part of processing container 64 in the second embodiment, it is not limited thereto and may be provided the sidewall part of processing container 64. Also, the position of gas introducing openings 84A, 84B for introducing a gas or the position of exhaust opening 94 for exhausting the gas is not limited to the position shown in FIG. 4.

### Third Embodiment

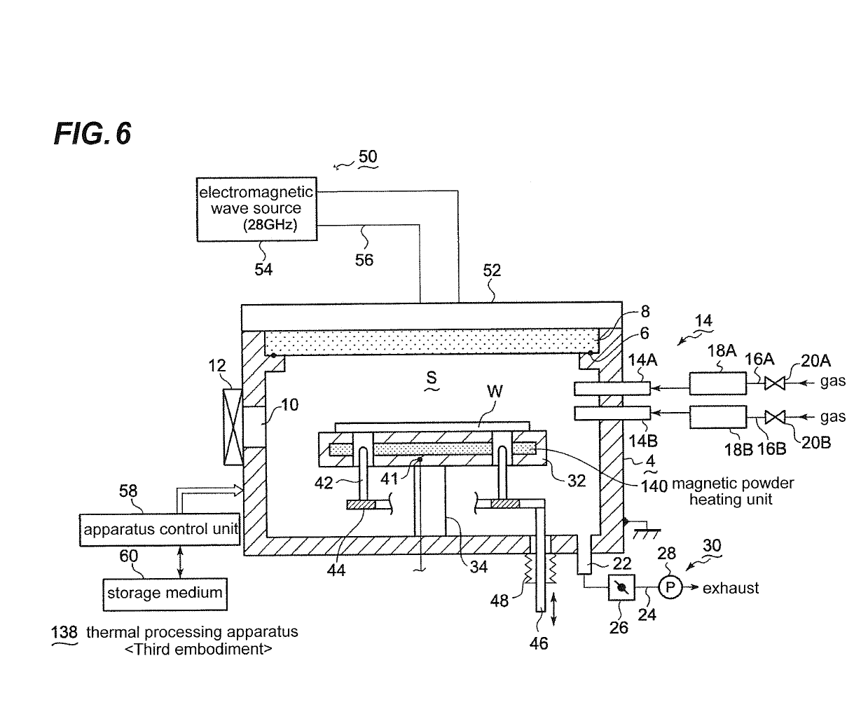

Next, a thermal processing apparatus according to the third embodiment of the present discloses will be described with reference to FIGS. 6 to 8. In the above first and second embodiments, although both of the heating by supplying power into resistance heating unit 36, 122 and the heating by supplying electromagnetic wave are used in combination, a magnetic powder heating unit comprised of magnetic powder is provided instead of the resistance heating unit, thereby performing only the heating by supplying electromagnetic wave.

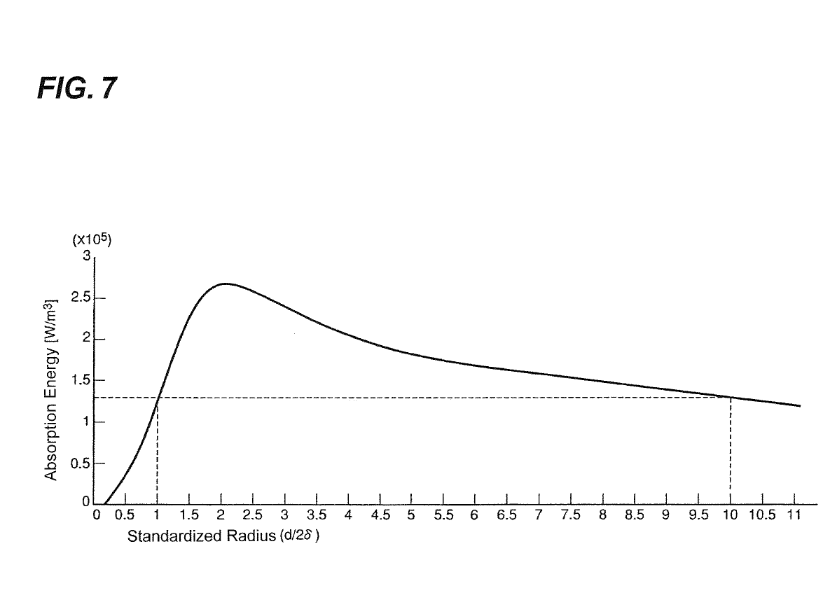

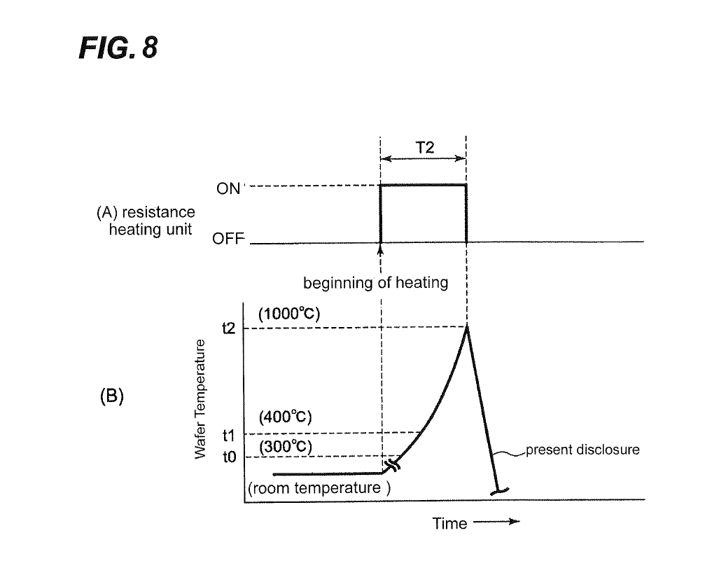

FIG. 6 is a view illustrating the configuration of a thermal processing apparatus according to the third embodiment of the present disclosure, FIG. 7 is a graph illustrating the relationship between a standardized radius of magnetic powder and absorption energy, and FIG. 8 is a graph illustrating the relationship between the driving of the electromagnetic wave introduction unit and the temperature of a semiconductor wafer. In addition, in FIG. 6, same reference numerals are used for same part as those shown in FIG. 1, and descriptions of same parts as those described above will be omitted.

As shown in FIG. 6, a thermal processing apparatus 138 of the third embodiment uses a magnetic powder heating unit 140, instead of resistance heating unit 36 on placing table 32 in the first embodiment shown in FIG. 1. Specifically, magnetic powder heating unit 140 formed by collecting the magnetic powder is embedded in placing table 32. Placing table 32 is made of a ceramic material having penetrability for electromagnetic wave such as silicon carbide, aluminum nitride or the like as described in the first embodiment, and magnetic powder heating unit 140 is built in placing table 32 so as to be embedded over approximately the entire surface thereof.

As for the magnetic powder, for example, iron oxide such as Fe₃O₄ or the like can be used, and the magnetic powder is charged to have a thickness of about 1 cm. The magnetic powder has a characteristic of being easily heated by electromagnetic wave as described below, and thus, resistance heating unit 36 and power source 40 that supplies power to resistance heating unit 36 may not be necessary.

The heating of the magnetic powder is carried out first by the magnetic heating explained with the equation for power of the electromagnetic wave heating. Thus, it has become easy for electromagnetic wave to invade between the powders by simply providing the magnetic powder, so that the magnetic powder can be heated rapidly and effectively even in the range of from a room temperature to a middle-low temperature of 600° C.

In this case, the optimum value for a standardized radius of magnetic powder (standardized radius) d/2δ is about 2.0 which is a peak value as shown in FIG. 7, and the peak value of absorption energy at this point is 2.5 W/m³. Moreover, “d” represents a radius of magnetic powder and “δ” represents a penetration depth which described below. Accordingly, in order to obtain absorption energy above half of the peak value, i.e., 1.3 W/m³, the standardized radius of magnetic powder d/2δ may be set to be within a range of 1.0˜10.

Thus, the optimum value of the radius (d) of magnetic powder is within a range of “2.0δ≦d≦20δ” and, by setting the radius of magnetic powder so as to satisfy this equation, the magnetic powder can be heated rapidly and effectively with the heating by generation of eddy current and the magnetic heating in which an electron spin is involved.

Herein, the “δ” represents a penetration depth [μm] which indicates a degree that electromagnetic field penetrates in depth direction of magnetic powder specimen and is calculated using the following equation:

δ=5.03×10⁷×(ρ/μr·f)

Herein, each symbol is as follows.

ρ: resistivity [Ωcm]

μr: relative permeability

f: frequency [Hz]

If the radius d is too small, since the potential difference generated on the surface of the magnetic powder is not enough, an eddy current is not generated effectively. Also if the radius (d) is too big, since an eddy current is generated only on the surface of the magnetic powder, only the surface is heated, whereas the inside thereof is not heated.

Regarding to this, since an eddy current is generated up to the inside of the magnetic powder by setting the radius (d) to be within the same range as described above, it is possible to selectively heat the magnetic powder rapidly and effectively. Moreover, it is generally difficult to control the radius (diameter) of magnetic powder with a high accuracy in a milling process, and the radius of magnetic powder follows a normal distribution. Accordingly, the peak value of this normal distribution may be taken as the radius d.

<Description of Operation>

Next, the operation of thermal processing apparatus 138 according to the third embodiment will be described with reference to FIGS. 7 and 8. Although the basic operation in the third embodiment is similar to the operations in FIGS. 1 to 3, herein, as shown in FIG. 8(A), electromagnetic wave introduction unit 50 is switched on at the same time when the heating begins thereby introducing electromagnetic wave into processing container 4. By doing this, the electromagnetic wave absorbs energy by the magnetic powder of magnetic powder heating unit 140 built in placing table 32 as described above, so that the temperature of the magnetic powder itself is elevated rapidly thereby heating placing table 32. Consequently, the semiconductor wafer W arranged on placing table 32 is temperature-elevated rapidly. In other words, magnetic powder heating unit 140 has all similar functions to resistance heating unit 36 of the first embodiment.

Then, the temperature of the semiconductor wafer is elevated and thereby the free electron density in the semiconductor wafer W formed with a silicon substrate slowly increases. When the temperature reaches t0˜t1, for example, 300° C. ˜400° C., the semiconductor wafer W itself is rapidly heated due to the increase of free electron density in addition to the heating from magnetic powder heating unit 140, thereby heated at a high temperature rising speed of about 200° C./sec.

Then, in the interval from this rapid temperature elevation to the processing temperature t2, for example, 1000° C., a film forming process having a short time constant is carried out. In this case, the irradiation time of electromagnetic wave T2 is, for example, about 100 msec to 10 sec. Accordingly, the third embodiment can have an approximately similar effect to the above first embodiment. Herein, iron oxide composed of Fe₃O₄ is used as for the magnetic powder, but one or more materials selected from a group including Fe, Ni, Co, MgO, Fe₃Si, iron oxide, chrome oxide, and ferrite can be used as well.

Therefore, according to the third embodiment of the present disclose, since the heating by electromagnetic wave of magnetic powder heating unit 140 provided in placing table 32 as a means for heating the semiconductor wafer W and the heating by electromagnetic wave of the object to be processed itself are used in combination, it is possible to obtain a high temperature rising speed.

### Forth Embodiment

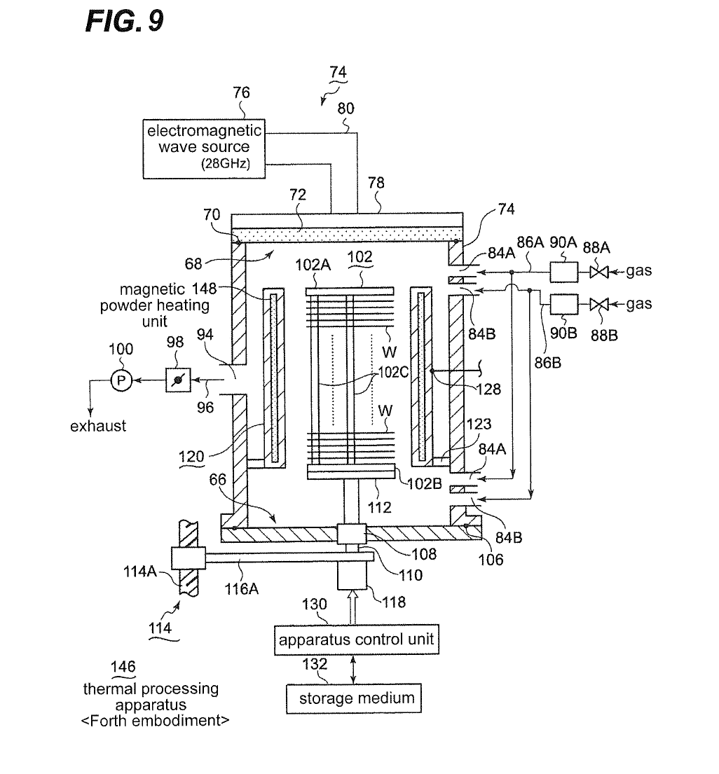

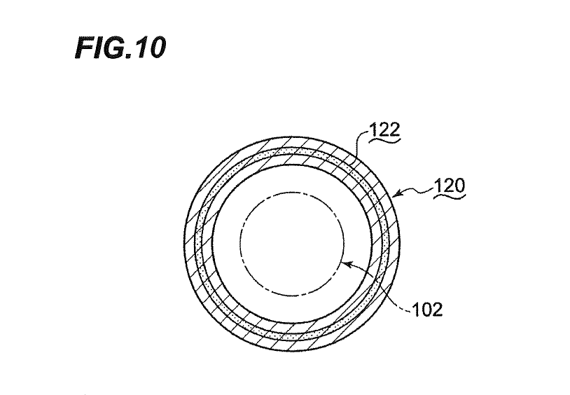

Next, a thermal processing apparatus according to the forth embodiment of the present disclose will be described. Although a single wafer type thermal processing apparatus using magnetic powder has been described in the third embodiment, the magnetic powder is applied to a batch type thermal processing apparatus capable of processing a plurality of semiconductor wafers at a time. FIG. 9 is a view illustrating the configuration of a thermal processing apparatus according to the forth embodiment of the present disclosure, and FIG. 10 is a lateral cross-sectional view illustrating schematically the heating means according to the forth embodiment. In addition, in FIGS. 9 and 10, same reference numerals are used for same part as those shown in FIGS. 4 and 5, and descriptions of the same parts as those described above will be omitted.

As shown in FIGS. 9 and 10, a thermal processing apparatus 146 of the forth embodiment uses a magnetic powder heating unit 148 instead of resistance heating unit 122 of heating means 120 of the second embodiment. Specifically, magnetic powder heating unit 140 formed by collecting magnetic powder is built in heating means 120. Heating means 120, as described in the second embodiment, is made of ceramic material such silicon carbide, aluminum nitride or the like that have a penetrability for electromagnetic wave, and magnetic powder heating unit 148 is built in heating means 120 so as to be embedded over the approximately entire surface thereof.

As for the magnetic powder, for example, iron oxide such as Fe₃O₄ or the like can be used as described in the third embodiment, and the magnetic powder is charged to have a thickness of about 1 cm. The magnetic powder has a characteristic of being easily heated by electromagnetic wave as described in the third embodiment. Therefore, resistance heating unit 122 and power source 126 that supplies power to resistance heating unit 122 provided in the second embodiment as shown in FIGS. 4 and 5 may not be necessary.

The heating of the magnetic powder is carried out first by the magnetic heating explained with the equation for power of the electromagnetic wave heating as described in the third embodiment. Thus, by simply providing the magnetic powder, it has become easy for electromagnetic wave to invade between the powders. As a result, the magnetic powder can be heated rapidly and effectively even in the range of form a room temperature to a middle-low temperature of 600° C.

<Description of Operation>

Next, the operation of thermal processing apparatus 146 of the forth embodiment will be described. Although the basic operation in the forth embodiment is similar to the operation described in FIG. 8, herein, as shown in FIG. 8(A), electromagnetic wave introduction unit 74 is switched on at the same time from the beginning of the heating thereby introducing electromagnetic wave into processing container 64. By doing this, the electromagnetic wave absorbs energy by the magnetic powder of magnetic powder heating unit 148 built in heating means 120 as described above, so that the temperature of the magnetic powder itself is elevated rapidly to heat heating means 120. Consequently, the temperature of the semiconductor wafer W surrounded by heating means 120 is also elevated rapidly. In other words, magnetic powder heating unit 148 has all the similar functions to resistance heating unit 122 of the second embodiment.

Then, the temperature of the semiconductor wafer is elevated and, as a result, the free electron density in the semiconductor wafer W formed by a silicon substrate slowly increases. When the temperature of the semiconductor wafer W reaches t0˜t1, for example, 300° C.˜400° C., the semiconductor wafer W itself is rapidly heated due to the increase of the free electron density in addition to the heating from magnetic powder heating unit 140. As a result, the semiconductor wafer W is heated at a high temperature rising speed of about 200° C./sec.

Then, during the interval from this rapid temperature elevation to the processing temperature t2, for example, 1000° C., a film forming process that has a short time constant having a short reaction speed is carried out as described above. In this case, the irradiation time of electromagnetic wave T2 is, for example, about 1 sec to 1500 sec. Accordingly, the forth embodiment can have an approximately similar effect to the above second embodiment. Herein, iron oxide formed with Fe₃O₄ is used as for the magnetic powder. However, one or more materials selected from a group including Fe, Ni, Co, MgO, Fe₃Si, iron oxide, chrome oxide and ferrite can be used as well.

Therefore, according to the forth embodiment of the present disclose, since both the heating by electromagnetic wave of magnetic powder heating unit 148 provided in heating means 120 as a means for heating the semiconductor wafer W and the heating by electromagnetic wave of the object to be processed itself are used in combination, it is possible to obtain a high temperature rising speed.

Further, although the processing container is arranged in a vertically standing up position has been described in the second and forth embodiments, the present discloses is not limited thereto and may be applied to a transverse type thermal processing apparatus in which the processing container is arranged in a horizontal direction. Further, although a film forming process is used as an exemplary thermal processing in each of the above embodiments, the present disclose is not limited thereto and may be applied to other thermal processing such as a oxidation/diffusion process, an annealing process and the like.

Further, although a semiconductor wafer formed by a silicon substrate is used as an object to be processed in each of the above embodiments, it is not limited thereto and the semiconductor wafer may be formed with a compound semiconductor such as GaAs, SiC, GaN and the like.

From the foregoing, it will be appreciated that various embodiments of the present disclosure have been described herein for purpose of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A thermal processing apparatus for performing a thermal processing on an object to be processed, comprising:
a metal-made processing container configured to be exhausted;
a placing table including a resistance heating unit and configured to arrange the object to be processed on the upper surface thereof;
a gas introduction unit configured to introduce a gas into the processing container;
an electromagnetic wave introduction unit configured to introduce an electromagnetic wave into the processing container; and
an apparatus control unit configured to control the thermal processing apparatus in its entirety.

2. A thermal processing apparatus for performing a thermal processing on an object to be processed, comprising:
a metal-made processing container configured to be exhausted and formed in a cylindrical body shape so as to accommodate a plurality of objects to be processed;
a holding means configured to hold the plurality of object to be processed and to be inserted or withdrawn into/from the processing container;
a heating means provided to surround the holding means in the processing container and including a resistance heating unit;
a gas introduction unit configured to introduce a gas into the processing container;
an electromagnetic wave introduction unit configured to introduce an electromagnetic wave into the processing container; and
an apparatus control unit configured to control the thermal processing apparatus it its entirety.

3. The thermal processing apparatus of claim 1, further comprising a temperature sensor unit configured to measure temperature of the object to be processed.

4. The thermal processing apparatus of claim 3, wherein the apparatus control unit is configured to turn on the electromagnetic wave introduction unit in response to a detection result from the temperature sensor unit that detects a predetermined temperature after turning on the resistance heating unit.

5. The thermal processing apparatus of claim 4, wherein the predetermined temperature is 300° C. or more.

6. A thermal processing apparatus for performing a thermal processing on an object to be processed, comprising:
a metal-made processing container configured to be exhausted;
a placing table having a built-in magnetic powder heating unit made by collecting magnetic powder and configured to arrange the object to be processed;
a gas introduction unit configured to introduce a gas into the processing container;
an electromagnetic wave introduction unit configured to introduce an electromagnetic wave into the processing container; and
an apparatus control unit configured to control the thermal processing apparatus in its entirety.

7. A thermal processing apparatus for performing a thermal processing on an object to be processed, comprising:
a metal-made processing container configured to be exhausted and formed in a cylindrical body shape so as to accommodate a plurality of objects to be processed;
a holding means configured to hold the plurality of objects to be processed and to be inserted or withdrawn into/from the processing container;
a heating means provided to surround the holding means in the processing container and having a built-in magnetic powder heating unit made by collecting magnetic power;
a gas introduction unit configured to introduce a gas into the processing container;
an electromagnetic wave introduction unit configured to introduce an electromagnetic wave into the processing container; and
an apparatus control unit configured to control the thermal processing apparatus in its entirety.

8. A thermal processing apparatus of the claim 6, wherein the magnetic power material is composed of one or more materials selected from a group consisting Fe, Ni, Co, MgO, Fe₃Si, iron oxide, chrome oxide, and ferrite.

9. A thermal processing apparatus of claim 8, wherein a standardized radius of the magnetic power material is within a range of 1.0 to 10.

10. A thermal processing apparatus of claim 1, wherein a frequency of the electromagnetic wave is within a range of 0.5 GHz to 5 THz.
